(19) United States
(12) Patent Application Publication
(10) Pub. No.: US 2007/0203604 A1
(43) Pub. Date: Aug. 30, 2007

(54) Product quality tracking system and method

(75) Inventors: Chaucer Chiu, Taipei (TW); Kitty Ji, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/363,673

(22) Filed: Feb. 27, 2006

(51) Int. Cl. G06F 19/00

(52) U.S. Cl. 700/109; 702/84

(57) ABSTRACT

A product quality tracking and method system is provided. The system includes a database having at least an identification code field for storing identification codes of a plurality of products, a reference numeral field for storing reference numerals of the products, and a quality message field; a reading device for reading the identification codes and the reference numerals of the products being tested; a recording module for recording quality test results of the products in the quality message field of the database corresponding to the identification codes and the reference numerals; and a statistic module for analyzing quality messages of a plurality of products having identical identification codes, and gathering statistics of quality problems of products in at least a model corresponding to at least one of the identification codes.

### BACKGROUND OF THE INVENTION

1. Field of the Invention

The present invention relates generally to a product quality tracking system and method, and more particularly, to a product quality tracking system and method connected via a network system to a client system and a product R&D system for tracking quality of products.

2. Description of Related Art

With the rapid development of electronic technologies, various electronic products have come to the market to satisfy human's demands. Before handing over an electronic device to a client, an electronic device manufacturer has to detect the problems of the electronic device. In practice, the electronic device manufacturer manufactures a predetermined number of samples for different models in the beginning, and then tests these samples to find and know if the samples meet predetermined quality requirements according to the test results. A product quality tracking system is one of the most important systems used in a product manufacturing and testing process.

In general, a modern product quality tracking system is composed of a website having a database. Testing engineers store reference numerals of different models of electronic devices after being tested in the database. Further, after testing the products, the testing engineers input the product problems to the product quality tracking system, allowing product R&D personnel to amend the electronic devices of a model to which the defective sample corresponds.

However, since there are a variety of models and testing items to be tested, the testing engineers' work is minute and complicated, and the testing engineers may easily get confuse with the status of the testing products. In consequence, the product quality tracking system of the prior art is lack of efficiency, and will increase the testing cost.

Moreover, the functionality of the product quality tracking system of the prior art is too simple, and does not have the capability to classify and analyze the problems of various product models. It is time consuming and error-prone if such work is done by man only. Moreover, since the detected product problems cannot be timely conveyed to the product R&D personnel, the product development cycle is prolonged. Additionally, the product quality tracking system of the prior art cannot timely receive quality feedback from a client end, so the manufacturers will not be able to quickly know the problems of the products and improve on their products.

Therefore, how to present an effective product quality tracking system and method to solve the drawbacks of the prior art has become one of the most important issues in the electronic industry.

### SUMMARY OF THE INVENTION

Accordingly, it is a primary objective of the present invention to solve the problems of the aforementioned conventional technology by providing a product quality tracking system and method, so as to promote working efficiency and reduce manufacturing cost.

It is another objective of the present invention to provide a product quality tracking system and method, so as to save time and manpower.

It is a further objective of the present invention to provide a product quality tracking system and method, so as to prevent errors in manual classifying and analyzing product problems from occurring.

It is yet another objective of the present invention to a product quality tracking system and method, which is connected via a network system to a client system and a product R&D system, so that product quality can be tracked timely and effectively, reducing product R&D cycle.

In order to attain the objectives mentioned above and the others, a product quality tracking system according to the present invention includes a database having at least an identification code field for storing identification codes of a plurality of products, a reference numeral field for storing reference numerals of the products, and a quality message field; a reading device for reading the identification codes and the reference numerals of the products being tested; a recording module for recording quality test results of the products in the quality message field of the database corresponding to the read identification codes and the reference numerals; and a statistic module for analyzing quality messages of a plurality of products having identical identification codes according to contents stored in the database, and gathering statistics of quality problems of products in at least a model corresponding to at least one of the identification codes.

The product quality tracking system is connected via a network system to a client system and a product R&D system. The product quality tracking system of the present invention further includes a transceiver module for transmitting the statistics of quality problems gathered by the statistic module via the network to a product R&D system, allowing product R&D personnel at the product R&D system to amend products according to the gathered statistics of quality problems. The transceiver module further receives amendment resolutions returned by product R&D system and stored the received amendment resolutions in the database. Further, the transceiver module transmits quality messages returned by the client system to the product R&D system, allowing the product R&D personnel at the product R&D system to amend products according the quality messages sent by the clients.

The product quality tracking method of the present invention includes establishing a database having at least an identification code field for storing identification codes of a plurality of products, a reference numeral field for storing reference numerals of the products, and a quality message field; reading identification codes and reference numerals of the products being tested; recording quality test results of the products in the quality message field of the database corresponding to the read identification codes and the reference numerals; and analyzing quality messages of a plurality of products having identical identification codes according contents stored in the database, and gathering statistics of quality problems of products in at least a model corresponding to at least one of the identification codes.

The method further includes transmitting the gathered statistics of quality problems via a network system to a product R&D system, and receiving via network system amendment resolutions returned by product R&D personnel at the product R&D system and storing the received amendment resolutions in the database.

The method further includes receiving via the network system quality messages fed back by the client system and storing the received quality messages in the database.

In contrast to the prior art, the product quality tracking system and method of the present invention first establishes the database, which comprises the identification codes and reference numerals of products ready to be tested. Then the reading device reads the identification codes and the reference numerals of the products being tested, allowing the recording module to record the quality test result of the products in the corresponding quality message fields according to the identification codes and the reference numerals. The statistic module therefore analyzes the products having the same identification codes according to the contents stored in the database, and gathers the statistics of quality messages of the products, so as to eliminate complicated manual works, promote working efficiency, and reduce working period.

Moreover, the product quality tracking system of the present invention can further be connected via the network system with the client system and the product R&D system, and exchanges information with the client system and the product R&D system via the network system. Therefore, product manufacturers can track the products timely and effectively, and R&D personnel of the product R&D system can know and solve the quality problems of the products in time to satisfy the demands required by clients.

### BRIEF DESCRIPTION OF DRAWINGS

The present invention can be more fully understood by reading the following detailed description of the preferred embodiments, with reference made to the accompanying drawings, wherein:

FIG. 1 is a block diagram of the product quality tracking system according to a first embodiment of the present invention and a plurality of products;

FIG. 2 is a block diagram of the product quality tracking system according to a second embodiment of the present invention;

FIG. 3 is a flow chart of the product quality tracking method corresponding to the product quality tracking system shown in FIG. 1;

FIG. 4 is a flow chart of a further embodiment of the product quality tracking method of FIG. 3; and

FIG. 5 is a flow chart of yet another embodiment of the product quality tracking method of FIG. 3.

### DETAILED DESCRIPTION OF THE PREFERRED EMBODIMENTS

The following description contains specific information pertaining to the implementation of the present invention. One skilled in the art will readily recognize other advantages and features of the present invention after reviewing what specifically disclosed in the present application. It is manifest that the present invention can be implemented and applied in a manner different from that specifically discussed in the present application. It should also be understood that the invention is not limited to the particular exemplary embodiments described herein, but is capable of many rearrangements, modifications, and substitutions without departing from the spirit of the present invention.

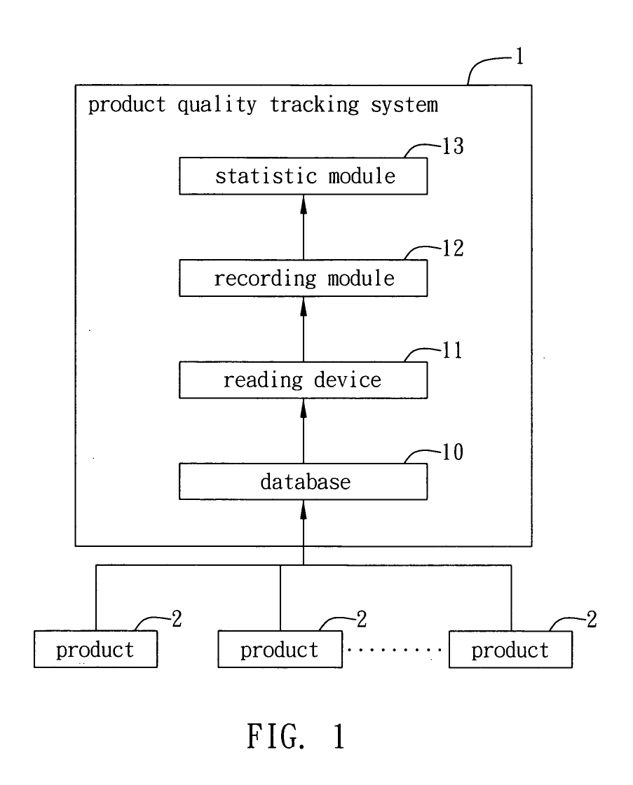

FIG. 1 is a block diagram of a product quality tracking system 1 and a plurality of products 2 of the preferred embodiment according to the present invention. The product quality tracking system 1 of the present invention is designed to track flaws of the products 2 in different or the same model to obtain quality information of the products 2 in any certain model.

The product quality tracking system 1 comprises a database 10, a reading device 11, a recording module 12 and a statistic module 13.

The database 10 comprises a plurality of identification code fields for storing identification codes of the products 2 in advance, a plurality of reference numeral fields for storing reference numerals (or product IDs) of the products 2 in advance, and a plurality of quality message fields. According to the preferred embodiment, the identification codes are bar codes on the products 2, the reference numerals are serial numbers given to the products 2 at production. In addition, the database 10 further comprises personnel data, such as names and job titles of R&D and quality control personnel in charge of the products 2.

The reading device 11 is used to read the identification codes and reference numerals of the products 2, and transmit the read identification codes and reference numerals to the recording module 12. According to the preferred embodiment, the reading device 11 is a scanner, which scans and reads the bar codes and serial numbers of the products 2, and transmits the read bar codes and serial numbers to the recording module 12. Of course, the reading device 11 can be replaced by other electronic devices having such reading functionality.

The recording module 12 is designed to record quality messages of the products 2 according to the identification codes and reference numerals transmitted from the reading device 11 into the quality message fields, which correspond to the identification codes and the reference numerals of the products 2. In detail, the recording module 12 records the quality messages generated during a quality testing process, and stores the quality messages of the products 2 into the quality message fields, which correspond to the received identification codes and the reference numerals of the products 2.

The statistic module 13 is used to analyze the products 2 having the same identification codes according to contents (identification codes, reference numerals and quality messages) stored in the database 10, and gather statistics of the quality messages of the products 2 having the same identification codes. Therefore, the R&D personnel or production line can refer to the gathered statistics of the quality messages to know and solve quality problems of the products 2. The static module 13 is able to provide statistical result based on the request of a user. According to the preferred embodiment, if a user wishes to know all the quality problems of the products 2, the statistics module 13 generates a summary report covering all of the quality problems of the products 2 and the personnel data, such as the names and job titles of the R&D and quality control personnel in charge of the products 2. If the user wants to know the statistics of the quality messages such as a percentage of the qualified products 2, the statistics module 13 generates a report of quality statistics, the report also covering the names and job titles of the R&D and quality control personnel in charge of the products 2.

The product quality tracking system 1 can be further connected with a client system and a product R&D system for exchanging information with the client system and the product R&D system.

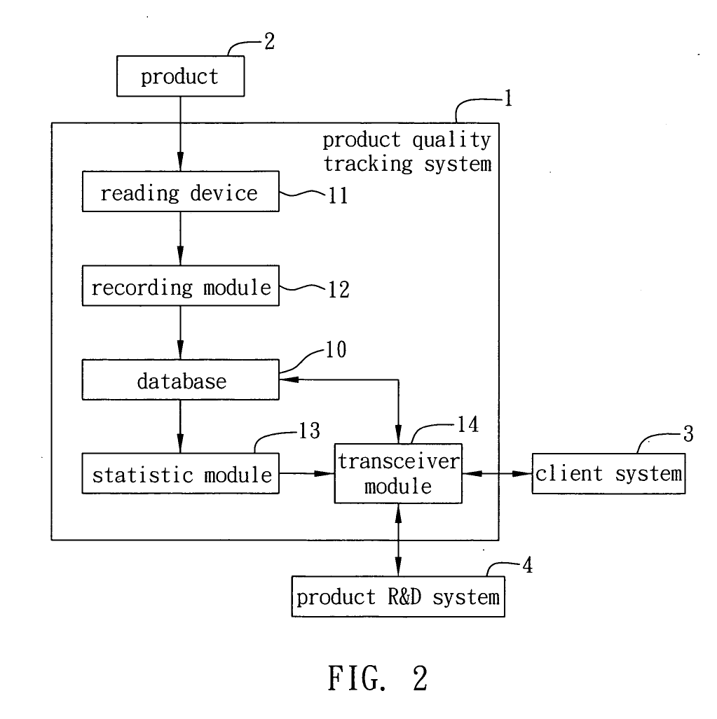

FIG. 2 is an application diagram showing the product quality tracking system 1 connected with and a client system 3 and a product R&D system 4. As shown in FIG. 2, the product quality tracking system 1 further comprises a transceiver module 14 for connecting via a network system to the client system 3 and the product R&D system 4. Therefore, the product quality tracking system 1 can exchange information with the client system 3 and the product R&D system 4.

According to a preferred embodiment, the network system is Internet, an inner network system (extranet) or any other equivalent information exchange system. The transceiver module 14 receives quality messages fed back by the client system 3 via the network system, and stores the quality messages in the database 10. The transceiver module 14 further transmits the quality messages fed back from the client system 3 via the network system to the product R&D system 4 for use by the R&D personnel so that they may design products having quality good enough to meet the demands of the clients.

Moreover, the transceiver module 14 can further transmit the gathered statistics of quality messages generated by the statistics module 13 via the network system to the product R&D system 4, and receive and store amendment resolution fed by the product R&D system 4 in the database 10. In a preferred embodiment, the transceiver module 14 may first refer to the information of R&D and/or testing personnel in charge of the testing recorded in a statistic result and transmits the statistics result (such as the report of quality statistics or the summary report above) to the related personnel in the product R&D system 4, effectively allowing the R&D personnel to know and solve the quality problems of the products 2. Such statistics results can also been transmitted to the quality control personnel to allow the quality personnel to know the quality problems of the products 2. The transceiver may then receive the amendment resolution transmitted by the R&D personnel. After receiving the amendment resolution, the transceiver module 14 stores them in the database 10 which allows all R&D and quality control personnel to know the current status (i.e. solved or unsolved) of these problems. According to such a scenario, the amendment resolution of a quality issue recorded in the database 10 can be easily viewed by all R&D personnel via the network system, which may act as a reference for future quality problems.

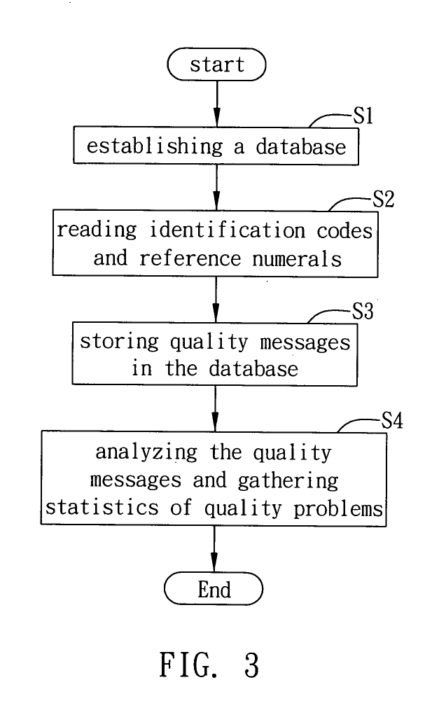

FIG. 3 is a flow chart of a product quality tracking method corresponding to the product quality tracking system 1 of the present invention. In step S1, the database 10 is established. The database 10 comprises the identification fields for storing a plurality of identification codes, the reference numeral fields for storing a plurality of reference numerals, and the quality message fields. Then proceed to step S2.

In step S2, the reading device 11 reads identification codes and reference numerals of the products 2 and transmits the read identification codes and reference numerals to the recording module 12. Then proceed to step S3.

In step S3, the recording module 12 records the quality messages of the products 2 according to the identification codes and reference numerals transmitted from the reading device 11 in the quality message fields, which correspond to the received identification codes and the reference numerals of the products 2. Then proceed to step S4.

In step S4, the statistic module 13 analyzes the products 2 having the same identification codes according to the contents (the identification codes, the reference numerals and the quality messages) stored in the database 10, and gather the statistics of the quality messages of the products 2 of a particular type of model having the same identification codes.

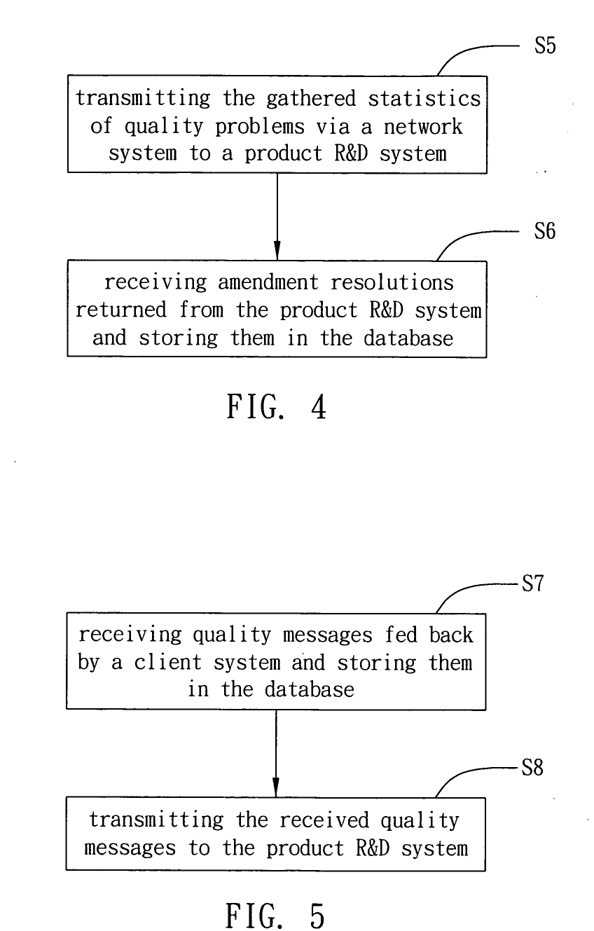

According to another embodiment of the present invention, after the statistic module 13 analyzing the quality messages of the products 2 having the same identification codes stored in the database 10 and gathering the statistics of quality messages of the products 2 of at least one type of model corresponding to at least one type of identification code, the product quality tracking method further comprises two steps, steps S5 and S6, shown in FIG. 4. In step S5, the transceiver module 14 transmits the statistics results generated by the statistics module 13 via the network system to the product R&D system 4 linked to the product quality tracking system 1, allowing the R&D personnel of the product R&D system 4 to amend the quality problems of the products 2 according to the statistics results. Then proceed to step S6.

In step S6, the transceiver module 14 receives the amendment resolution about a particular model returned by the R&D personnel of the product R&D system 4 via the network system, and stores the received amendment resolution in the database 10.

According to another embodiment of the present invention, the product quality tracking method further comprises two steps, steps S7 and S8, shown in FIG. 5. In step S7, the transceiver module 14 receives the quality messages fed back by clients of the client system 3 linked to the product quality tracking system 1 via the network system, and stores the quality messages in the database 10. Then proceed to step S8.

In step S8, the transceiver module 14 transmits the quality messages fed by the client system 3 via the network system to the product R&D system 4, allowing the R&D personnel of the product R&D system 4 to make the use of the quality messages fed by the client system 3 to amend the quality problems of the products 2, so as to satisfy the demands of the clients.

In summary, the product quality tracking system and method of the present invention first establishes the database, which comprises the identification codes and reference numerals of products ready to be tested. Then the reading device reads the identification codes and the reference numerals of the products, allowing the recording module to record the quality messages of the products in the corresponding quality message fields according to the identification codes and the reference numerals. The statistic module therefore analyzes the products having the same identification codes according to the contents stored in the database, and gathers the statistics of quality messages of the products, so as to eliminate complicated manual works, promote working efficiency, and reduce working period.

Moreover, the product quality tracking system of the present invention can further be connected via the network system with the client system and the product R&D system, and exchanges information with the client system and the product R&D system via the network system. Therefore, product manufacturers can track the products timely and effectively, and R&D personnel of the product R&D system can know and solve the quality problems of the products in time to satisfy the demands required by clients.

The above-described exemplary embodiments are to describe various objects and features of the present invention as illustrative and not restrictive. A person of ordinary skill in the art would recognize that changes could be made in form and detail without departing from the sprit and the scope of the invention. Thus, the right protection scope of the present invention should fall within the appended claim.

What is claimed is:

1. A product quality tracking system comprising:
a database having at least an identification code field for storing identification codes of a plurality of products, a reference numeral field for storing reference numerals of the products, and a quality message field;
a reading device for reading the identification codes and the reference numerals of the products being tested;
a recording module for recording quality test results of the products in the quality message field of the database corresponding to the identification codes and the reference numerals read by the reading device; and
a statistic module for analyzing quality test results of a plurality of products having identical identification codes according to contents stored in the database, and gathering statistics of quality problems of products in at least a model corresponding to at least one of the identification codes.

2. The product quality tracking system of claim 1, being connected via a network system to a product Research and Development (R&D) system and a client system.

3. The product quality tracking system of claim 2, further comprising a transceiver module for transmitting the statistics of quality problems gathered by the statistic module to the product R&D system, allowing R&D personnel at the R&D system to amend quality problems of products according to the gathered statistics of quality problems.

4. The product quality tracking system of claim 3, wherein the transceiver module receives via the network system amendment resolutions returned by the R&D personnel at the R&D system and stores the amendment resolutions in the database.

5. The product quality tracking system of claim 2, further comprising a transceiver module for receiving via the network system quality messages fed by the client system, and storing the received quality messages in the database.

6. The product quality tracking system of claim 5, wherein the transceiver module further transmits via the network system the quality messages fed back by the client system to the R&D system, allowing the R&D personnel at the R&D system to amend quality problems of products according to the quality messages.

7. The product quality tracking system of claim 1, wherein the identification codes are bar codes on the products.

8. The product quality tracking system of claim 1, wherein the reference numerals are serial numbers given to the products at production.

9. The product quality tracking system of claim 1, wherein the reading device is a scanner.

10. A product quality tracking method, comprising the steps of:
establishing a database having at least an identification code field for storing identification codes of a plurality of products, a reference numeral field for storing reference numerals of the products, and a quality message field;
reading identification codes and reference numerals of the products being tested;
recording quality test results of the products in the quality message field of the database corresponding to the read identification codes and the reference numerals; and
analyzing quality messages of a plurality of products having identical identification codes according to the contents stored in the database, and gathering statistics of quality problems of products in at least a model corresponding to at least one of the identification codes.

11. The product quality tracking method of claim 10, further comprising receiving via a network system quality messages fed back by a client system, and storing the received quality messages in the database.

12. The product quality tracking method of claim 11, further comprising transmitting the quality messages fed back by the client system via the network system to a product R&D system, allowing R&D personnel at the product R&D system to amend products according to the received quality messages.

13. The product quality tracking method of claim 10, further comprising transmitting the gathered statistics of quality problems via a network system to a product R&D system.

14. The product quality tracking method of claim 11, further comprising receiving via the network system amendment resolutions returned from the R&D system.
